(19) United States
(12) Patent Application Publication
(10) Pub. No.: US 2025/0040744 A1
(43) Pub. Date: Feb. 6, 2025

(54) INDUCTIVELY HEATED KETTLE

(71) Applicant: C. Cretors & Company, Wood Dale, IL (US)

(72) Inventors: Charles D. Cretors, Lake Forest, IL (US); Nilesh J. Darji, Niles, IL (US); Nenad Vidojevic, Chesterton, IN (US)

(21) Appl. No.: 18/793,667

(22) Filed: Aug. 2, 2024

Related U.S. Application Data
(60) Provisional application No. 63/517,514, filed on Aug. 3, 2023.

(51) Int. Cl. A47J 27/00; H05B 6/06; H05B 6/12

(52) U.S. Cl. CPC A47J 27/004; H05B 6/062; H05B 6/1209

(57) ABSTRACT

Induction kettles for cooking food, such as corn kernels to make popcorn, and associated systems and methods, are disclosed herein. In some embodiments, an induction kettle can include (i) a kettle bottom, (ii) an induction assembly including an induction coil, and (iii) a spacer coupling the kettle bottom to the induction assembly. A power supply can supply power to the induction coil for inductively heating the kettle bottom. During heating, the spacer can maintain a fixed separation distance between the kettle bottom and the induction assembly when the kettle bottom deflects (e.g., dishes upward or downward) due to thermal expansion. For example, the spacer can press against and deflect the induction assembly to deflect the induction coil to match the deflection of the kettle bottom.

### CROSS-REFERENCE TO RELATED APPLICATION(S)

The present application claims the benefit of U.S. Provisional Patent Application No. 63/517,514, filed Aug. 3, 2023, the disclosure of which is incorporated herein by reference in its entirety.

### TECHNICAL FIELD

The present disclosure generally relates to devices and methods for inductively heating a kettle to heat and cook a food product, such as corn kernels to make popcorn.

### BACKGROUND

Conventional devices for making popcorn typically include a popcorn kettle with a thick steel bottom and heating elements bolted onto the bottom. A batch of corn kernels and oil is added to the kettle after the kettle bottom is heated to a temperature of around 350 degrees Fahrenheit. A thermostat turns the heating elements on, raising the temperature of the kettle bottom to around 450 degrees Fahrenheit over a time of around 3 minutes. During this heating period, starch in the corn kernels cooks and becomes gelatinized, and the internal pressure rises as the moisture inside the corn kernels turns to steam. When the internal pressure reaches around 130 pounds per square inch (psi), the pericarp (hull) of the corn kernels ruptures and the steam expands, then cools as the corn pops and the internal pressure drops to atmospheric pressure. The soft gelatinized cells stretch out and cool to the foam-like structure commonly associated with popcorn. The popcorn in the kettle is then dumped, and the kettle bottom cools back to a temperature of around 350 degrees Fahrenheit, at which time another batch of corn kernels and oil can be added.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 is a perspective view of an induction popcorn kettle configured in accordance with embodiments of the present technology.

FIGS. 2A and 2B are side views of the induction popcorn kettle of FIG. 1 in accordance with embodiments of the present technology.

FIGS. 3A-3C are top views of different portions of the induction popcorn kettle of FIG. 1 in accordance with embodiments of the present technology.

FIG. 4 is a flowchart illustrating a method of operating an induction popcorn kettle in accordance with embodiments of the present technology.

### DETAILED DESCRIPTION

The present technology is generally directed to devices and methods for heating and cooking a food product, such as corn kernels to make popcorn. In conventional induction popcorn kettles, a kettle bottom, on which corn kernels are heated and popped, and an induction coil are provided at an initially fixed separation distance. In particular, the separation distance between the kettle bottom and the induction coil is selected to optimize induction heating. As the kettle heats up, however, the kettle bottom can deflect (e.g., dish downward or upward) due to thermal expansion while the induction coil remains fixed in position, thereby changing the separation distance between the kettle bottom and the induction coil. The permissible range of the separation distance for optimal induction heating may be narrow, so excessive deflection of the kettle bottom may bring the separation distance outside of the range for optimal induction heating. For example, if the separation distance becomes too small, the kettle may result in excessive resistive heating via the induction coil and cause corn kernels on the kettle bottom to cook too fast or burn.

Embodiments of the present technology can address this issue. In some embodiments, for example, an induction popcorn kettle can include (i) a kettle bottom, (ii) an induction assembly including an induction coil, and (iii) a spacer coupling the kettle bottom to the induction assembly. A power supply can supply power to the induction coil for inductively heating the kettle bottom. During heating, the spacer can maintain a fixed separation distance between the kettle bottom and the induction assembly when the kettle bottom deflects (e.g., dishes upwardly or downwardly) due to thermal expansion. For example, the spacer can press against and deflect the induction assembly to deflect the induction coil to match the deflection of the kettle bottom. Maintaining a fixed, or at least substantially fixed, separation distance between the induction coil and the kettle bottom in the foregoing manner during induction heating can ensure that the kettle bottom is heated at a desired temperature and can enable more precise control of the induction parameters.

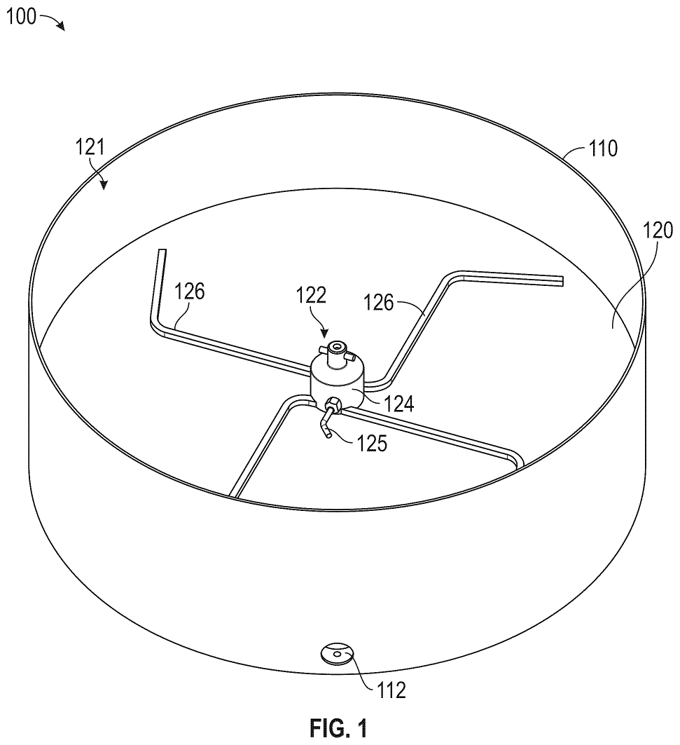

Certain details are set forth in the following description and in FIGS. 1-4 to provide a thorough understanding of various embodiments of the present technology. In other instances, well-known structures, materials, operations and/or systems often associated with popcorn kettles, motors, drive systems, induction heating assemblies and components, and/or the like are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a perspective view of an induction popcorn kettle 100 (“kettle 100”) configured in accordance with embodiments of the present technology. In the illustrated embodiment, the kettle 100 includes a kettle wall 110 and a kettle bottom 120 secured within/to the kettle wall 110. The kettle wall 110 and the kettle bottom 120 can together define a receptacle 121 for receiving a food product, such as corn kernels, therein. The kettle 100 can further include a stirring assembly 122 positioned within the receptacle 121 over/on the kettle bottom 120. The stirring assembly 122 can include a hub 124 positioned at or near, and disposed over a central portion of the kettle bottom 120, and a plurality of stirring blades 126 coupled to the hub 124 via, for example, one or more fasteners 125. In some embodiments, the hub 124 can include a protrusion, e.g., a cylindrical boss, that extends downwardly from a lower portion thereof and is rotatably received in a corresponding circular aperture in the central portion of the kettle bottom 120. The hub 124 can be operably coupled to a motor via a drive shaft (the motor and the drive shaft are not shown in FIG. 1) that rotates the hub 124 and the attached stirring blades 126 within the receptacle 121 to, for example, stir a food product therein. For example, in some embodiments an upper end portion of the hub 124 can include a feature (e.g., a cross-pin, etc.) that releasably engages a lower end portion of a drive shaft that extends downwardly from a motor positioned above the kettle bottom 120. In the illustrated embodiment, there are four of the stirring blades 126, and each of the stirring blades 126 has an elongated shape that extends in a generally radial direction from the hub 124 toward the kettle wall 110. In other embodiments, there can be fewer or more of the stirring blades 126 and/or the stirring blades 126 can have different shapes and sizes.

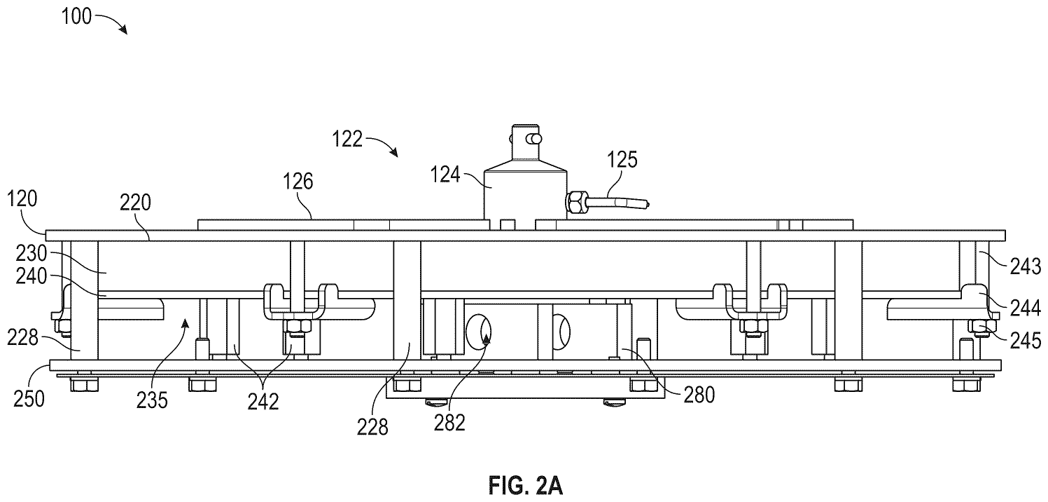

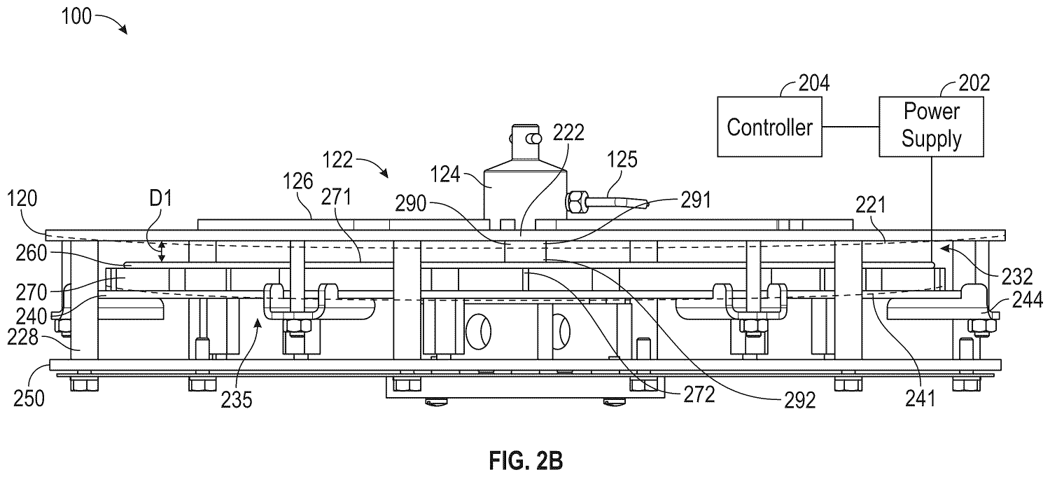

As described in greater detail below with reference to FIGS. 2A-4, the kettle 100 includes an induction assembly below the kettle bottom 120 configured to inductively heat the kettle bottom 120 to heat and cook a food product received within the receptacle 121 on/over the kettle bottom 120. Accordingly, the kettle bottom 120 can be made of an electrically-conductive material appropriate for induction heating such as steel, stainless steel, carbon steel, cast iron, brass, aluminum, copper, and/or the like. The stirring blades 126 can be rotated during heating to stir the food product for more even heating and cooking. In some embodiments, a lid or other cover (not shown) can be placed over the receptacle 121 (e.g., coupled to an upper portion of the kettle wall 110) to maintain the food product therein and/or to retain heat therein. In some aspects of the present technology, the kettle 100 can be relatively large and/or the kettle bottom 120 can reach very high temperatures (e.g., 300-500 degrees Fahrenheit) during and/or after an induction heating cycle such that a shaft or other tool may be desirable to lift the kettle 100 and dump the prepared food product (e.g., popcorn). The kettle wall 110 can include a wall aperture 112 for receiving such shaft or tool.

FIG. 2A is a side view of the induction popcorn kettle 100 of FIG. 1 with the kettle wall 110 omitted for clarity in accordance with embodiments of the present technology. In the illustrated embodiment, the kettle 100 includes an induction assembly 235 positioned below the kettle bottom 120 and having an induction wall 230 and an induction base 240. The induction wall 230 and the induction base 240 can be made of metal (e.g., aluminum), ceramic, and/or other suitably rigid and/or heat-resistant materials. The induction assembly 235 can be fixed to the kettle bottom 120. For example, in the illustrated embodiment the induction assembly 235 is clamped to a bottom surface 220 of the kettle bottom 120 via clamps 244. The clamps 244 can be spaced around a perimeter of the kettle 100 and can be secured to corresponding rods or studs 243 mounted to the bottom surface 220 of the kettle bottom 120. The clamps 244 can extend at least partially under the induction base 240 to support the induction assembly 235 and can be tightened (e.g., via bolts 245) to clamp and tighten the induction assembly 235 against the kettle bottom 120. In some embodiments, the induction wall 230 is annular and does not include a top portion or cover such that the kettle bottom 120, the induction wall 230, and the induction base 240 define an enclosed space 232 (FIG. 2B) when the induction assembly 235 is clamped to the kettle bottom 120.

In the illustrated embodiment, the kettle 100 further includes a kettle base 250 positioned below the induction base 240. The kettle bottom 120 can be coupled to the kettle base 250 and supported by a plurality of bottom support columns 228 extending between a perimeter of the kettle bottom 120 and the kettle base 250. In some embodiments, the induction base 240 is coupled to and supported by a plurality of induction support columns 242 extending between the induction base 240 and the kettle base 250. The induction support columns 242 can support the induction base 240 at locations radially outward from the center of the induction base 240, allowing the center of the induction base 240 to move or deflect (e.g., downwardly) as discussed in further detail below. The kettle 100 can further include one or more lift structures 280, each with an aperture 282 configured to receive the shaft or tool for lifting and dumping the kettle 100, as described above with reference to FIG. 1. In some embodiments, the apertures 282 are aligned with the wall aperture 112 illustrated in FIG. 1. In the illustrated embodiment, there is a gap between the induction base 240 and the lift structures 280 to allow the induction base 240 to deflect downward.

FIG. 2B is a side view of the induction popcorn kettle 100 with the induction wall 230 of the induction assembly 235 omitted for clarity in accordance with embodiments of the present technology. In the illustrated embodiment, the induction assembly 235 includes an induction coil 260 positioned below the kettle bottom 120 within the enclosed space 232 and a board 270 positioned below the induction coil 260 within the enclosed space 232 such that the induction coil 260 is positioned over/on the board 270. In some embodiments, the induction coil 260 comprises a flexible coil. In some embodiments, the induction coil 260 can be attached to the board 270 via adhesives, fasteners, and/or other attachment mechanisms. In other embodiments, the induction coil 260 or multiple induction coil portions (e.g., segments) can be attached directly (via, e.g., adhesive) to an underside of the kettle bottom 120. For example, a plurality of individual induction coil portions can be bonded to the underside of the kettle bottom 120 and either connected in series to the power supply 202 or individually connected to one or more power supplies. The use of multiple induction coil portions in this configuration enables the induction coil portions to move with the kettle bottom 120 as it deflects, thereby maintaining a fixed distance between the kettle bottom 120 and the coil portions during kettle heating. In other embodiments, a single induction coil can be attached to the kettle bottom 120 and shaped and sized so that it deflects with the kettle bottom 120 during heating to maintain the desired spatial relationship between the induction coil 260 and the kettle bottom 120. Attaching the induction coil or individual induction coil portions to the underside of kettle bottom 120 enables the board 270 to be omitted. The board 270 can be a phenolic board made of a dielectric material (e.g., a relatively stiff material, such as Bakelite) supported by the induction base 240 that provides electrical insulation between the induction coil 260 and the induction base 240.

In some embodiments, the induction wall 230 and/or the induction base 240 can be omitted, and the board 270 can be supported by direct contact with the support columns 242 and/or the clamps 244. For example, the columns 242 and/or the clamps 244 can hold or support the board 270 and the induction coil 260 thereon, as opposed to the clamps 244 clamping the induction base 240 and the induction wall 230 to the kettle bottom 120. In some embodiments, the studs 243 can each include a shoulder that limits where (e.g., how high) a nut or other fastener and/or the clamp 244 can be coupled to the stud 243, thereby defining a minimum separation distance between the kettle bottom 120 and the clamps 244, and thus the board 270 and the induction coil 260 thereon.

A spacer 290 is operably positioned between a central portion 222 of the kettle bottom 120 and a central portion 272 of the board 270. That is, the spacer 290 can have an upper end portion 291 that contacts the bottom surface 220 of the kettle bottom 120 and a lower end portion 292 that contacts an upper surface 271 of the board 270. As noted above, in some embodiments, the hub 124 can include a central boss (not shown) that extends downwardly through a central aperture in the kettle bottom 120. In some embodiments, a portion of the boss (or a protrusion extending therefrom) can extend downwardly below the kettle bottom 120, and the upper end portion 291 of the spacer 290 can include a central aperture (also not shown) configured to receive the extended portion of the boss. The resultant engagement between the spacer 290 and the boss extending downwardly from the hub 124 ensures that the spacer 290 remains in position (e.g., centered, or at least approximately centered) during operation of the kettle 100.

In other embodiments, kettle 100 can include other components and/or features (e.g., fasteners) to ensure that the spacer 290 remains centered, or at least approximately centered, during kettle operation. For example, in some embodiments, the kettle 100 can further include one or more insulating materials (e.g., one or more circular pads of insulating material, such as aerogel) positioned directly on top of the induction coil 260. In some embodiments, the insulating material can include a central aperture that receives the spacer 290 and thereby centers spacer in the kettle 100. As described in greater detail below, the spacer 290 can maintain a fixed spacing between the kettle bottom 120 and the induction coil 260 during operation of the kettle 100 to, for example, provide for predictable and consistent induction heating. In some embodiments, the induction coil 260 is operatively coupled to a power supply 202, which can be operatively coupled to a controller 204 wirelessly or through a wired connection.

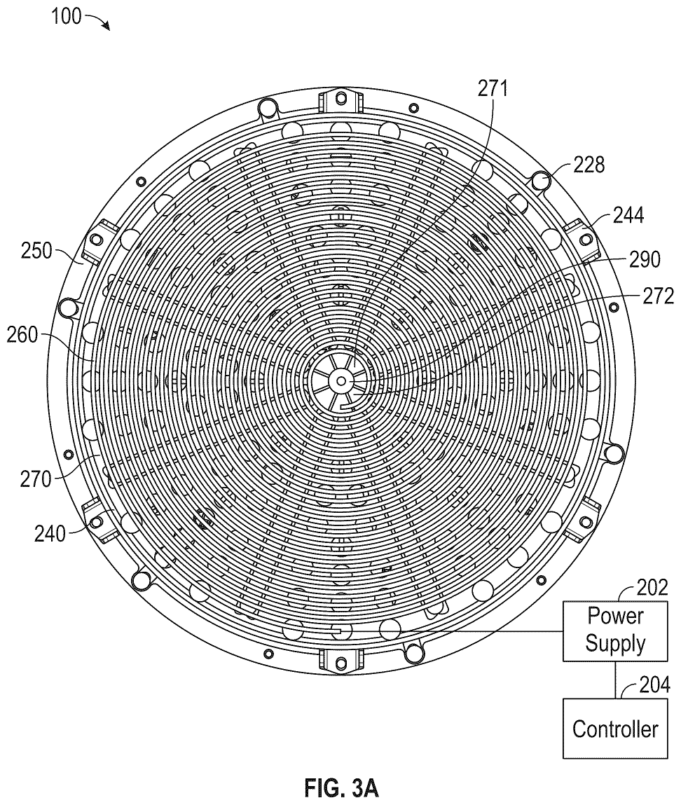

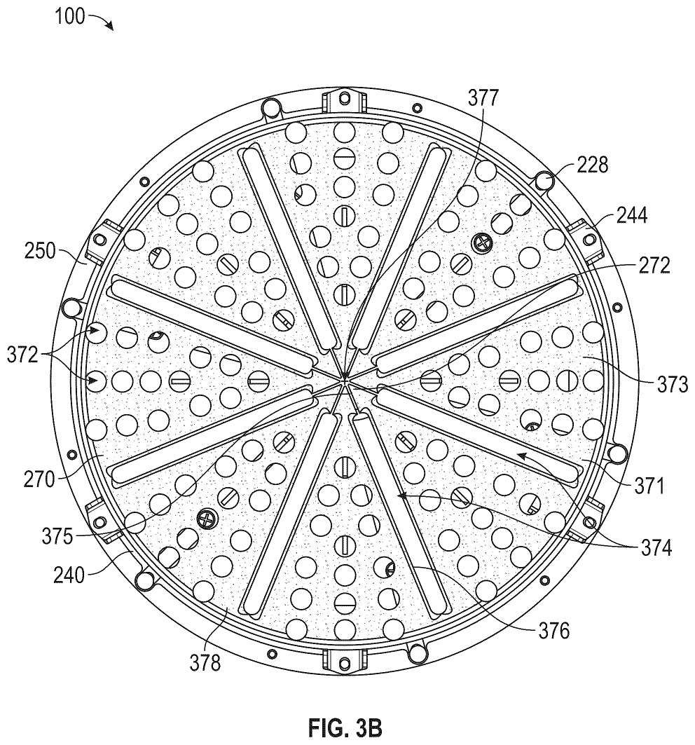

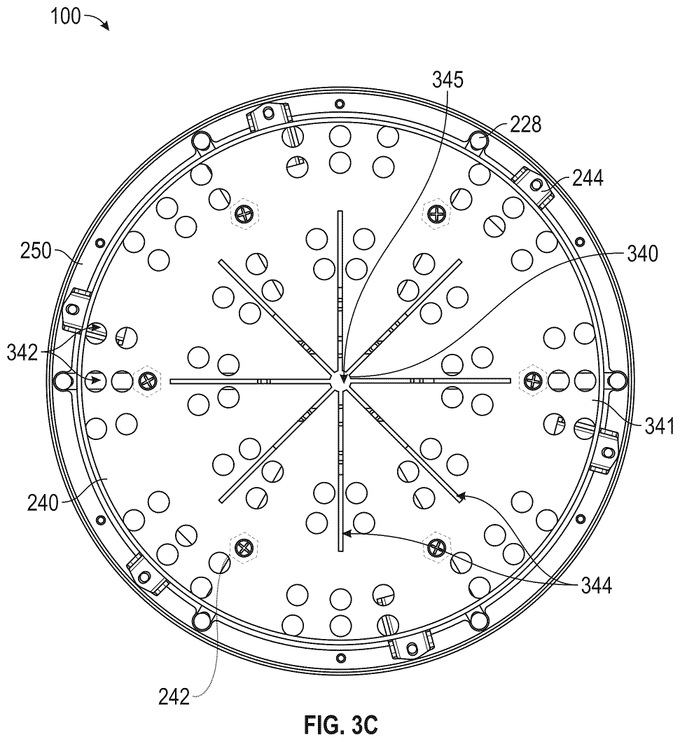

FIGS. 3A-3C are top views of the induction popcorn kettle 100 illustrating different portions or layers of the kettle 100 in accordance with embodiments of the present technology. More specifically, FIG. 3A is a top view of the kettle 100 with the kettle wall 110, the kettle bottom 120, and the stirring assembly 122 removed. FIG. 3B is a top view of the kettle 100 with the induction coil 260 and the spacer 290 further removed from the embodiment illustrated in FIG. 3A. And, FIG. 3C is a top view with the kettle 100 with the board 270 further removed from the embodiment illustrated in FIG. 3B.

Referring to FIG. 3A, the induction coil 260 can be coiled atop the board 270 in a spiral-like pattern. In the illustrated embodiment, the induction coil 260 does not coil fully toward the central portion 272 of the board 270 to leave space for the lower end portion 292 (FIG. 2B) of the spacer 290 to contact the upper surface 271 of the board 270 near the central portion of the board 270. In some aspects of the present technology, covering a large cross-sectional area of the kettle 100 with the induction coil 260 can help evenly distribute induction heating of the kettle bottom 120 (FIGS. 1-2B). In other embodiments, the induction coil 260 can be positioned atop the board 270 in a different pattern. As discussed above with respect to FIG. 2B, the induction coil 260 can be operatively coupled to a power supply 202 controlled by a controller 204. While FIG. 3A schematically illustrates the power supply 202 connected to only one end of the induction coil 260, one of ordinary skill in the art will appreciate that the power supply 202 can be connected to the other end of the induction coil 260 near the central portion of the board 270 via, e.g., a wire that extends therebetween over an insulating material atop the induction coil 260. In some embodiments, the spacer 290 includes one or more notches for wires to extend therethrough between the induction coil 260 and the power supply 202.

In some embodiments, the board 270 can be made from a stiff and relatively brittle dielectric material (e.g., Bakelite) that may be unable to flex to a sufficient degree without breaking. Referring to FIG. 3B, the board 270 (depicted by a dotted pattern in FIG. 3B for illustrative purposes) can include one or more slots, openings, grooves, cutouts, punchouts, apertures, and/or the like positioned to allow the board 270 to flex during operation of the kettle 100, notwithstanding the relatively stiff and brittle nature of the board material. In the illustrated embodiment, for example, the board 270 includes/defines a plurality of slots 374 extending from the central portion 272 of the board 270 at least partially radially outward toward a perimeter portion 371 of the board 270. In some embodiments, the slots 374 each include (i) an inner portion 375 along the central portion 272 of the board and having a first circumferential width and (ii) an outer portion 376 extending radially away from the inner portion 375 to and/or proximate the perimeter portion 371 of the board 270 and having a second circumferential width greater than the first width. The slots 374 can be interconnected at a central aperture 377 in the central portion 272 of the board 270. In the foregoing manner, the slots 374 can define a plurality of wedge-shaped portions or wedges 373 of the board 270 that are interconnected at and extend inwardly from the perimeter portion 371 of the board 270. The central portion 272 can comprise the tips of the plurality of wedge-shaped portions 373. In other embodiments, the board 270 can have other arrangements or patterns of slots, cut-outs, etc. to enable the board 270 to flex as desired during kettle operation. For example, in some embodiments the board 270 can include a plurality of wedge-shaped portions or wedges that are interconnected at and extend outwardly from the central portion 272 of the board 270, and may not be interconnected along the perimeter portion 371 of the board 270. The slots that define such wedges can further help the board 270 flex to a sufficient degree without breaking. The thickness of the board 270 can also be selected to allow the board 270 flex to a sufficient degree without breaking.

In the illustrated embodiment, the induction coil 260 has a spiral, or at least generally spiral, shape. In other embodiments, the induction coil 260 can be disposed on the board 270 in other shapes. For example, the induction coil 260 can comprise a plurality of coil portions that each sits atop one of the wedges 373 of the board 270. Each coil portion can have a wedge-shaped form factor corresponding to each of the wedges 373. The coil portions can be electrically isolated from one another or connected to one another in series and to a power source.

Also, in the illustrated embodiment, the board 270 can be made from a single piece of material with a unitary construction. In other embodiments, the board 270 can comprise a plurality of separate board portions. For example, in some embodiments, the wedges 373 can be individual pieces that are separate from each other and held in position with a fixture and/or connected together via fasteners, adhesives, and/or other coupling mechanisms. As non-limiting examples, the kettle 100 can further include a ring having a diameter similar to the diameter of the board 270, and the separate wedges can be independently coupled to the ring and extend inward. As another non-limiting example, the kettle 100 can further include a member at the center of the board 270 and couples the separate wedges together at their tip portions.

Referring to FIGS. 3A and 3B, the spacer 290 (FIG. 3A) can be positioned over the central aperture 377 and/or at least a portion of the inner portions 375 of the slots 374 at the central portion 272. In some embodiments, the outer portions 376 do not extend fully through the perimeter portion 371 of the board 270 such that board 270 defines a continuous annular support portion 378 proximate to the perimeter thereof. In the illustrated embodiment, the board 270 includes eight of the slots 374 that are symmetrically in a spoke-like pattern. In other embodiments, the board 270 can include a different number of the slots 374, some or all of the slots 374 can have different shapes, etc.

In some embodiments, the board 270 further includes/defines a plurality of holes 372 positioned between some or all of the slots 374, such as between the outer portions 376 of the slots 374. In the illustrated embodiment, the holes 372 each have a circular cross-sectional shape and are arranged in a radially symmetric pattern across the board 270. In other embodiments, the holes 372 can have different shapes and/or sizes, and/or the board 270 can have fewer or more of the holes 372. For example, the holes 372 can be of various shapes (e.g., square, triangle, oval) and sizes, and arranged in a different pattern (e.g., axisymmetric, asymmetric). The holes 372 function to facilitate cooling of one or more components of the kettle 100, such as the board 270 and/or the induction base 240, by providing a greater surface area for airflow.

Referring to FIG. 3C, the induction base 240 can similarly include one or more slots, openings, grooves, cutouts, punchouts, apertures, and/or the like positioned to allow the induction base 240 to flex during operation of the kettle 100. In the illustrated embodiment, for example, the board 270 includes/defines a plurality of slots 344 extending from a central portion 340 of the induction base 240 at least partially radially outward toward a perimeter portion 341 of the induction base 240. In some embodiments, the slots 344 can each have a generally constant circumferential width and can be joined together at a central aperture 345. Referring to FIGS. 3A and 3C, the spacer 290 (FIG. 3A) can be positioned at least partially over the central aperture 345. Referring to FIGS. 3B and 3C, the slots 374 in the board 270 can further toward the perimeter of the kettle 100 (e.g., can be shorter) than the slots 344 in the induction base 240. In some embodiments, the slots 344 in the induction base 240 are aligned with or generally aligned with the slots 374 in the board 270.

Referring again to FIG. 3C, in some embodiments the induction base 240 further includes/defines a plurality of holes 342 positioned between and/or around the slots 344. In the illustrated embodiment, the holes 342 each have a circular cross-sectional shape and are arranged in a radially symmetric pattern across the induction base 240. In other embodiments, the holes 342 can have different shapes and/or sizes, and/or the induction base 240 can have fewer or more of the holes 342. For example, the holes 342 can be of various shapes (e.g., square, triangle, oval) and sizes, and arranged in a different pattern (e.g., axisymmetric, asymmetric). The holes 342 function to facilitate cooling of one or more components of the kettle 100, such as the board 270 and/or the induction base 240, by providing a greater surface area for airflow. Referring to FIGS. 3B and 3C, in some embodiments one or more of the holes 372 in the board 270 can align with one or more of the holes 342 in the induction base 240 when the board 270 is positioned atop the induction base 240.

Referring to FIGS. 2A-3C together, during operation of the kettle 100 in an induction heating cycle, the controller 204 can control the power supply 202 to output power to the induction coil 260. The current flowing in the induction coil 260 can generate an electromagnetic field that acts to inductively heat the kettle bottom 120. As the temperature of the kettle bottom 120 rises, the kettle bottom 120 can expand due to thermal expansion. However, because the perimeter portion of the kettle bottom 120 is fixed in position by the bottom support columns 228, the central portion of the kettle bottom 120 will deflect upward or downward (e.g., dish). In some embodiments, the kettle bottom 120 is dished downward initially (e.g., at room or ambient temperature, e.g., 59° F.-77° F.) prior to heating so that the deflection of the kettle bottom 120 occurs predictably in a downward direction during heating of the kettle bottom 120. For example, if the central portion of the kettle bottom 120 moves downward, the kettle bottom 120 can dish downward to align with the dashed line 221 (FIG. 2B). In other embodiments, the kettle bottom 120 is dished upward initially so that the deflection of the kettle bottom 120 occurs predictably in an upward direction during heating of the kettle bottom 120. The maximum initial deflection distance of the kettle bottom 120 (e.g., at the center of the kettle bottom 120) can be 1/16-¼ inch, such as ⅛ inch.

If the induction coil 260 were to remain fixed in the illustrated position while the kettle bottom 120 deflects upward or downward, a separation distance D1 (FIG. 2B) between the induction coil 260 and the kettle bottom 120 would change. In some embodiments, the separation distance D1 is selected to optimize induction heating, and the range of the separation distance D1 for optimal induction heating may be narrow. Therefore, excessive deflection of the kettle bottom 120 may bring the separation distance D1 outside of the range for optimal induction heating. For example, if the separation distance D1 becomes too small, the kettle 100 may result in excessive resistive heating in the induction coil 260 and cause food products in the receptacle 121 (FIG. 1) to cook too fast or burn.

In some aspects of the present technology, the spacer 290 acts to maintain the separation distance D1 (e.g., keep the separation distance D1 constant) when the kettle bottom 120 deflects during heating. For example, as the kettle bottom 120 deflects downward as illustrated by line 221 (FIG. 2B) upon thermal expansion, the central portion 222 (FIG. 2B) of the kettle bottom 120 moves downward and pushes the spacer 290 downward. The spacer 290 then pushes against the central portion 272 of the board 270. The clamps 244 keep the perimeter portions of the induction base 240 and the board 270 fixed in position, so the spacer 290 deflects the board 270 downward as illustrated by the dashed line 241 (FIG. 2B). More particularly, the slots 374 and the aperture 377 in the board 270 allow the board 270 to deflect/flex downward in response to downward movement of the spacer 290. As a result, in some embodiments, the board 270 can deflect in the shape of a flat cone.

The central portion 272 of the board 270 pushes against the central portion 340 of the induction base 240, deflecting the induction base 240 downward as well. The slots 344 and the aperture 345 in the induction base 240 similarly allow the induction base 240 to deflect/flex downward in response to downward movement of the board 270 and the spacer 290. In some embodiments, the induction coil 260, which is positioned atop the board 270, comprises a flexible coil that can flex or bend with and along the curvature of the upper surface 271 of the board 270 such that the separation distance D1 between the kettle bottom 120 and the induction coil 260 remains constant. In some embodiments, the spacer 290 acts to maintain the separation distance D1 between the induction coil 260 and the kettle bottom 120 a desired range optimal for induction heating (e.g., between about 3-10 millimeters) during an induction heating cycle.

In the illustrated embodiment, the kettle bottom 120, the induction coil 260, the board 270, and the induction base 240 deflect downward, so the spacer 290 need not be coupled to the board 270 and can simply push downward. However, if the kettle bottom 120 deflects upward upon thermal expansion, the spacer 290 can be coupled to the board 270 to correspondingly lift the board 270 and the induction coil 260 upward upon thermal expansion. In some embodiments, the kettle bottom 120 is installed onto the bottom support columns 228 in a downward-bent state (e.g., before induction heating) such that the kettle bottom 120 predictably deflects downward, instead of upward, upon thermal expansion.

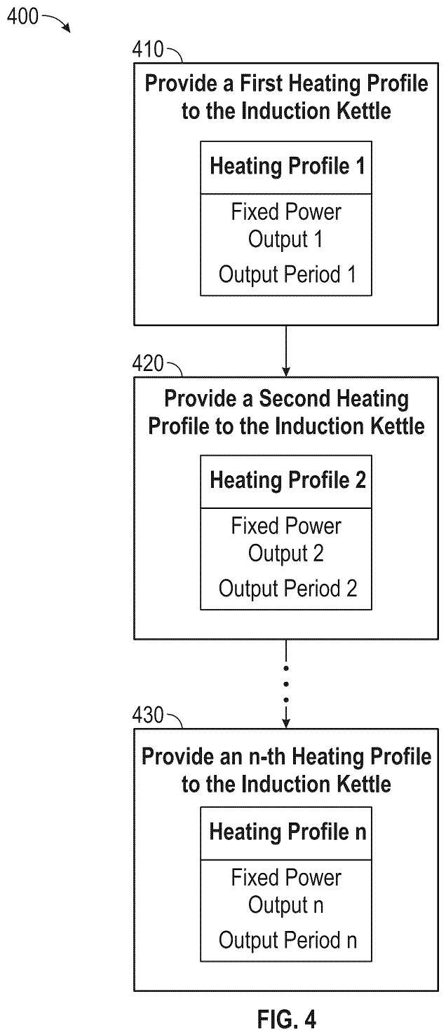

Lines 221 and 241 are merely illustrative of the general direction of deflection of the kettle bottom 120 and the board 270, and do not represent the exact curvature of the bending, the degree of deflection, etc. As will be described in further detail below with respect to FIG. 4, in some embodiments, the controller 204 can control the power supply 202 to provide a plurality of heating profiles to the induction coil 260 for controlled induction heating of the kettle bottom 120.

FIG. 4 is a flowchart illustrating a process or method 400 of operating an induction kettle to heat a food product, such as popcorn, in accordance with embodiments of the present technology. The method 400 can be used to operate, for example, the induction kettle 100 illustrated in and described with respect to FIGS. 1-3C. Accordingly, some aspects of the method 400 are described with reference to FIGS. 1-3C.

One advantage of induction heating is that induction heating can provide much higher heating rates than convection and radiation processes. However, such rapid heating may be undesirable in certain circumstances. For example, when cooking popcorn, the temperature of a non-induction kettle is often raised from around 350 degrees Fahrenheit to around 450 degrees Fahrenheit over a period of 3 minutes. This controlled heating process allows the starch in corn kernels to become gelatinized, and the soft gelatinized cells stretch out to form the foam-like structure commonly associated with popcorn. However, induction heating can cook the popcorn too quickly, which can cause the starch in the corn kernel to become hard and dense instead of soft and gelatinized. Therefore, there is a need to control the heating rate of an induction kettle.

At block 410, the method 400 includes providing a first heating profile to the induction kettle 100. In the illustrated embodiment, the first heating profile has a first fixed power output “Fixed Power Output 1” and a first output period “Output Period 1” during which the Fixed Power Output 1 is provided to the induction kettle. At block 420, the method 400 includes providing a second heating profile to the induction kettle 100 after the first heating profile. The second heating profile includes a second fixed power output “Fixed Power Output 2” and a second output period “Output Period 2” during which the Fixed Power Output 2 is provided to the induction kettle 100. At block 430, the method includes providing an n-th heating profile to the induction kettle 100 after the second (or any subsequent) heating profile. The n-th heating profile includes an n-th fixed power output “Fixed Power Output n” and an n-th output period “Output Period n” during which the Fixed Power Output n is provided to the induction kettle 100. The heating profiles can be provided by a power supply (e.g., the power supply 202) according to instructions from a controller (e.g., the controller 204). The fixed power outputs of the first, second, and n-th heating profiles (i.e., Fixed Power Output 1, Fixed Power Output 2, Fixed Power Output n) and/or the output periods (i.e., Output Period 1, Output Period 2, Output Period n) can be different such that variable energy inputs can be provided to the induction kettle. The heating profiles can be set such that induction heating can mimic the heating rate of other methods of heating, such as oil-based heating. In some embodiments, providing additional heating profiles and/or periods of no heating are included in the method. One example method providing six different heating profiles is shown in the table below.

| | Fixed Power | Output Period | Total Time |
|---|---|---|---|
| Heating Profile | Output (Watts) | (seconds) | Elapsed (minutes) |
| 1 | 6000 | 30 | 0.5 |
| 2 | 2100 | 30 | 1 |
| 3 | 4100 | 30 | 1.5 |
| 4 | 4850 | 30 | 2 |
| 5 | 5600 | 60 | 3 |
| 6 | 3500 | 30 | 3.5 |

As shown in the table above, the first fixed power output (i.e., 6000 W) is set high to take advantage of induction heating's ability to raise the temperature of the kettle 100 very quickly. After 30 seconds, the power output is lowered to a second fixed power output (i.e., 2100 W) to avoid cooking the food (e.g., popcorn) too quickly. After another 30 seconds, the next three heating profiles can be used to gradually increase the fixed power output (i.e., from 4100 W to 4850 W to 5600 W) and the corresponding temperature of the kettle 100. The fifth heating profile has an output period of 60 seconds, whereas the other heating profiles shown each has an output period of 30 seconds. Finally, the heating is decreased to a sixth fixed power output (i.e., 3500 W). As aforementioned, the various heating profiles can be set to mimic or improve upon other methods of heating to, for example, properly gelatinize starch in corn kernels. The total time elapsed can also be controlled to be similar to the total time elapsed when cooking using non-induction heating. In other embodiments, other fixed power outputs (e.g., 500 W, 1500 W, 3000 W, 6500 W) and other output periods (e.g., 15 seconds, 45 seconds, 90 seconds, 120 seconds) can be included in a heating profile.

Many embodiments of the technology described herein may take the form of computer- or machine- or controller-executable instructions, including routines executed by a programmable computer or controller. Those skilled in the relevant art will appreciate that the technology can be practiced on computer/controller systems other than those shown and described below. The technology can be embodied in a special-purpose computer, controller or data processor that is specifically programmed, configured or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. An induction kettle, comprising:
a kettle bottom configured to deflect upon being heated;
an induction assembly including an induction coil configured to inductively heat the kettle bottom; and
a spacer coupling the kettle bottom to the induction assembly, wherein the spacer is configured to maintain a fixed spacing between the kettle bottom and the induction coil when the kettle bottom deflects.

2. The induction kettle of example 1, further comprising:
a kettle base, wherein a perimeter portion of the kettle bottom is coupled to the kettle base at a fixed distance such that a central portion of the kettle bottom is configured to move when the kettle bottom deflects, and wherein the spacer is coupled to the central portion of the kettle bottom.

3. The induction kettle of example 1 or example 2 wherein the spacer is configured to be coupled to a central portion of the kettle bottom.

4. The induction kettle of any one of examples 1-3 wherein the induction assembly further includes:
a board configured to support the induction coil, wherein the spacer is coupled to a central portion of the board such that the central portion of the board is configured to move when the kettle bottom deflects.

5. The induction kettle of example 4 wherein the board includes a plurality of slots extending radially outward from the central portion of the board.

6. The induction kettle of example 4 or example 5 wherein the induction assembly further includes:
an induction base configured to support the board, wherein a perimeter portion of the induction base is coupled to a perimeter portion of the kettle bottom at a fixed distance.

7. The induction kettle of example 6 wherein the induction base includes a plurality of slots extending radially outward from a central portion of the induction base.

8. The induction kettle of any one of examples 1-7, further comprising an insulating material between the kettle bottom and the induction coil.

9. A method of operating an induction kettle, comprising:
providing a first heating profile to the induction kettle; and
providing a second heating profile to the induction kettle,
wherein each of the first and second heating profiles has a fixed power output and an output period, and
wherein the fixed power output of the first heating profile is different from the fixed power output of the second heating profile.

10. The method of example 9 wherein the fixed power output of each of the first and second heating profiles ranges between 1500 watts and 6500 watts.

11. The method of example 9 or example 10 wherein the output period of each of the first and second heating profiles ranges between 15 seconds and 90 seconds.

12. The method of any one of examples 9-11 wherein the first and second heating profiles are configured to gelatinize starch in corn kernels when the induction kettle is cooking popcorn.

13. The method of any one of examples 9-12 wherein the first and second heating profiles are provided by a power supply configured to be controlled by a controller.

14. An induction kettle, comprising:
a kettle bottom configured to deflect upon being heated;
an induction assembly including an induction coil configured to inductively heat the kettle bottom;
a spacer coupling the kettle bottom to the induction assembly, wherein the spacer is configured to maintain a fixed spacing between the kettle bottom and the induction coil when the kettle bottom deflects; and
a power supply configured to provide first and second heating profiles to the induction coil, wherein each of the first and second heating profiles has a fixed power output and an output period, and wherein the fixed power output of the first heating profile is different from the fixed power output of the second heating profile.

15. An induction kettle, comprising:
a kettle bottom configured to deflect upon being heated;
an induction assembly including an induction coil configured to inductively heat the kettle bottom; and
a spacer in contact with the kettle bottom and the induction assembly, wherein the spacer is configured to maintain a fixed spacing between the kettle bottom and the induction coil when the kettle bottom deflects.

16. The induction kettle of example 15, further comprising:
a kettle base, wherein a perimeter portion of the kettle bottom is coupled to the kettle base at a fixed distance such that a central portion of the kettle bottom is configured to move when the kettle bottom deflects, and wherein the spacer is in contact with the central portion of the kettle bottom.

17. The induction kettle of example 15 or example 16 wherein the kettle bottom includes a central aperture, and wherein the induction kettle further comprises:
a hub disposed over a central portion of the kettle bottom, wherein the hub includes a protrusion extending through and beyond the central aperture of the kettle bottom, and wherein the spacer includes a feature configured to receive the protrusion of the hub.

18. The induction kettle of any one of examples 15-17 wherein the induction assembly further includes:
a board configured to support the induction coil, wherein the spacer is in contact with a central portion of the board such that the central portion of the board is configured to move when the kettle bottom deflects.

19. The induction kettle of example 18 wherein the board includes a plurality of slots extending radially outward from the central portion of the board.

20. The induction kettle of example 19, wherein the plurality of slots define a plurality of wedges interconnected at and extending inwardly from a perimeter portion of the board, wherein each of the wedges includes a corresponding tip portion, and wherein the central portion of the board includes the tip portions of the wedges.

21. The induction kettle of any one of examples 15-20 wherein the induction assembly further includes:
an induction base configured to support the induction coil, wherein a perimeter portion of the induction base is coupled to a perimeter portion of the kettle bottom at a fixed distance.

22. The induction kettle of example 21 wherein the induction assembly further includes:
an induction wall extending between the kettle bottom and the induction base, wherein the induction base and the induction wall are clamped against a bottom surface of the kettle bottom.

23. The induction kettle of example 21 wherein the induction base includes a plurality of slots extending radially outward from a central portion of the induction base.

24. The induction kettle of any one of examples 15-23, further comprising an insulating material positioned between the kettle bottom and the induction coil.

25. The induction kettle of any one of examples 15-24 wherein the kettle bottom is dished downward prior to being heated.

26. The induction kettle of any one of examples 15-25 wherein the spacer is in contact with a central portion of the kettle bottom and a central portion of the induction assembly.

27. A method of operating an induction kettle, comprising:
providing a first heating profile to the induction kettle; and
providing a second heating profile to the induction kettle,
wherein each of the first and second heating profiles has a fixed power output and an output period, and
wherein the fixed power output of the first heating profile is different from the fixed power output of the second heating profile.

28. The method of example 27 wherein the fixed power output of each of the first and second heating profiles ranges between 1500 watts and 6500 watts.

29 The method of example 27 or example 28 wherein the output period of each of the first and second heating profiles ranges between 15 seconds and 90 seconds.

30. The method of any one of examples 27-29 wherein the first and second heating profiles are configured to gelatinize starch in corn kernels when the induction kettle is cooking popcorn.

31. The method of any one of examples 27-30 wherein the first and second heating profiles are provided by a power supply controlled by a controller.

32 The method of any one of examples 27-31 wherein the induction kettle includes a kettle bottom and an induction coil, and wherein the method further comprises maintaining a constant distance between the kettle bottom and the induction coil while providing both the first and second heating profiles.

33. An induction kettle, comprising:
a kettle bottom configured to deflect upon being heated;
an induction assembly including an induction coil configured to inductively heat the kettle bottom;
a spacer operably disposed between the kettle bottom and the induction assembly, wherein the spacer is configured to maintain a fixed spacing between the kettle bottom and the induction coil when the kettle bottom deflects; and
a controller configured to modulate power to the induction coil to provide first and second heating profiles to the kettle bottom, wherein each of the first and second heating profiles has a fixed power output and an output period, and wherein the fixed power output of the first heating profile is different from the fixed power output of the second heating profile.

34 The induction kettle of example 33, wherein the fixed power output of each of the first and second heating profiles ranges between 1500 watts and 6500 watts, and wherein the output period of each of the first and second heating profiles ranges between 15 seconds and 90 seconds.

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize. The teachings of the present technology provided herein can be applied to other systems, not necessarily the system described herein. The elements and acts of the various embodiments described herein can be combined to provide further embodiments. Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. An induction kettle, comprising:
a kettle bottom configured to deflect upon being heated;
an induction assembly including an induction coil configured to inductively heat the kettle bottom; and
a spacer coupling the kettle bottom to the induction assembly, wherein the spacer is configured to maintain a fixed spacing between the kettle bottom and the induction coil when the kettle bottom deflects.

2. The induction kettle of claim 1, further comprising:
a kettle base, wherein a perimeter portion of the kettle bottom is coupled to the kettle base at a fixed distance such that a central portion of the kettle bottom is configured to move relative to the kettle base when the kettle bottom deflects, and wherein the spacer is coupled to the central portion of the kettle bottom.

3. The induction kettle of claim 1 wherein the kettle bottom includes a central aperture, and wherein the induction kettle further comprises:
a rotatable hub carrying one or more stirring blades, wherein the hub includes a protrusion extending downwardly through the central aperture of the kettle bottom, and wherein the spacer is operably coupled to the hub.

4. The induction kettle of claim 1 wherein the induction assembly further includes:
a board configured to support the induction coil, wherein the spacer is in contact with a central portion of the board such that the central portion of the board is configured to move when the kettle bottom deflects.

5. The induction kettle of claim 4 wherein the board includes a plurality of slots extending radially outward from the central portion of the board.

6. The induction kettle of claim 5, wherein the plurality of slots define a plurality of wedges interconnected at and extending inwardly from a perimeter portion of the board, wherein each of the wedges includes a corresponding tip portion, and wherein the central portion of the board includes the tip portions of the wedges.

7. The induction kettle of claim 1 wherein the induction assembly further includes:
an induction base configured to support the induction coil, wherein a perimeter portion of the induction base is coupled to a perimeter portion of the kettle bottom at a fixed distance.

8. The induction kettle of claim 7 wherein the induction assembly further includes:
an induction wall extending between the kettle bottom and the induction base, wherein the induction base and the induction wall are clamped against a bottom surface of the kettle bottom.

9. The induction kettle of claim 7 wherein the induction base includes a plurality of slots extending radially outward from a central portion of the induction base.

10. The induction kettle of claim 1, further comprising an insulating material operably positioned between the kettle bottom and the induction coil.

11. The induction kettle of claim 1 wherein the kettle bottom is dished downward prior to being heated.

12. The induction kettle of claim 1 wherein the spacer is in contact with a central portion of the kettle bottom and a central portion of the induction assembly.

13. A method of operating an induction kettle, comprising:
providing a first heating profile to the induction kettle; and
providing a second heating profile to the induction kettle,
wherein each of the first and second heating profiles has a fixed power output and an output period, and
wherein the fixed power output of the first heating profile is different from the fixed power output of the second heating profile.

14. The method of claim 13 wherein the fixed power output of each of the first and second heating profiles ranges between 1500 watts and 6500 watts.

15. The method of claim 13 wherein the output period of each of the first and second heating profiles ranges between 15 seconds and 90 seconds.

16. The method of claim 13 wherein the first and second heating profiles are configured to gelatinize starch in corn kernels when the induction kettle is cooking popcorn.

17. The method of claim 13 wherein the first and second heating profiles are provided by a power supply controlled by a controller.

18. The method of claim 13 wherein the induction kettle includes a kettle bottom and an induction coil, and wherein the method further comprises maintaining a constant distance between the kettle bottom and the induction coil while providing the first heating profile and providing the second heating profiles.

19. An induction kettle, comprising:
a kettle bottom configured to deflect upon being heated;
an induction assembly including an induction coil configured to inductively heat the kettle bottom;
a spacer coupling the kettle bottom to the induction assembly, wherein the spacer is configured to maintain a fixed spacing between the kettle bottom and the induction coil when the kettle bottom deflects; and
a controller configured to modulate power to the induction coil to provide first and second heating profiles to the kettle bottom, wherein each of the first and second heating profiles has a fixed power output and an output period, and wherein the fixed power output of the first heating profile is different from the fixed power output of the second heating profile.

20. The induction kettle of claim 19, wherein the fixed power output of each of the first and second heating profiles ranges between 1500 watts and 6500 watts, and wherein the output period of each of the first and second heating profiles ranges between 15 seconds and 90 seconds.
